(19) United States
(12) Patent Application Publication
(10) Pub. No.: US 2023/0279985 A1
(43) Pub. Date: Sep. 7, 2023

(54) THERMAL AND ACOUSTIC INSULATION

(71) Applicant: L&C Protec, Inc. d/b/a Cocoon, Inc., North Hampton, NH (US)

(72) Inventors: John Peter Lord, Derry, NH (US); Leo J. Crotty, New Castle, NH (US); Mark Crotty, Kittery Point, ME (US); Katherine A. McNamara, West Newbury, MA (US)

(73) Assignee: L&C Protec, Inc. d/b/a Cocoon, Inc., North Hampton, NH (US)

(21) Appl. No.: 17/685,556

(22) Filed: Mar. 3, 2022

(51) Int. Cl. F16L 59/02; B32B 3/02; B32B 5/18; B32B 5/32; B32B 5/02; B32B 5/24

(52) U.S. Cl. CPC F16L 59/026; F16L 59/029; B32B 3/02; B32B 5/18; B32B 5/32; B32B 5/024; B32B 5/245; B32B 5/022; B32B 5/026; B32B 2266/025; B32B 2307/73; B32B 2307/7265; B32B 2266/06; B32B 2307/102; B32B 2307/304; B32B 2307/3065; B32B 2262/04; B32B 2262/0261; B32B 2262/0269; B32B 2262/144; B32B 2307/724; B32B 2255/02; B32B 2307/21; B32B 2255/20; B32B 2262/148; B32B 2262/152

(57) ABSTRACT

An improved acoustic and thermal insulation batting for use, for example, between airframe ribs in aircrafts, and that is stable, lightweight, air permeable to mitigate corrosion issues as well as inherently fire resistant and sized and shaped such that there is no need for positive retention mechanisms owing to the nature of the batting which allows for a compression or friction fit in place. The batting comprises a foam insulation core over which is provided one or more barrier, facing and/or edge layers.

### TECHNICAL FIELD

The present invention relates to insulation and more particularly, to an improved thermal and acoustic insulation batting which provides a breathable insulation foam core thus achieving a high level of thermal and acoustic insulation and is inherently fire resistant.

### BACKGROUND INFORMATION

Providing both thermal and acoustic insulation in aircraft has long been accomplished using standard fiberglass insulation. There have been no changes to this concept since the original design in the early 1950s. For example, C-130 aircraft have such legacy fiberglass insulation that is non-breathable and can trap water, oils, sand, salts, dust, and pollutants against the airframe, causing corrosion damage. In addition, fiberglass insulation hung vertically is difficult to attach to the airframe with a relatively ineffective attachment system, which results in loose and sagging insulation blankets that regularly require attention and maintenance. Some advances have been made in the usage of polymeric materials, particularly foams. The primary developments have made use of closed-cell foams, which also suffer from the above-mentioned prior art condition of trapping water, oils, sand, salts, dust and pollutants against the airframe, causing corrosion damage. Such foams include polyurethane-based foams, polyvinylidene fluoride foams, vinyl-nitrile rubber blends, and the like.

Accordingly, what is needed is an improved acoustic and thermal insulation batting for use, for example, between airframe ribs in aircrafts, and that is stable, lightweight, air permeable to mitigate corrosion issues as well as inherently fire resistant and is able to be installed by compression or friction fitting the insulation within a cavity of the aircraft without the need for additional fasteners or adhesives.

### SUMMARY OF THE INVENTION

The invention features an open cell, flame resistant and vibration resistant foam that resists compression set, is covered or enclosed on all sides by a microporous membrane, is impervious to liquid water penetration as well as petroleum and lubricants, repels sand and dust while allowing air and moisture vapor flow out of the batting, and includes a durable fiber-based exterior textile or composite membrane with hydrophobic and oleophobic properties and an electrostatic dissipating carbon-based print.

The invention features an acoustic and thermal insulation batting comprising a foam core having a thickness, first and second major planar surfaces, and four edges defined by the foam core thickness and disposed between the first and second major planar surfaces of the foam core. At least a first barrier membrane is disposed on each the first and second major planar surfaces of the foam core. An edge binding is disposed on the four edges defined by the foam core.

In one embodiment, the at least a first barrier membrane is an expanded polytetrafluoroethylene (ePTFE) membrane, treated to be hydrophobic and oleophobic via a fluorocarbon treatment, with a resistance to water penetration of at least 10,000 mm of H₂O when tested to ISO 811, and air permeable to a level of at least 0.10 ft³/min/ft².

Another embodiment further includes a facing and backing textile fabric membrane, the facing and backing textile fabric membrane is disposed over the at least a first barrier membrane.

In the preferred embodiment, the foam core is open cell in structure and treated to be resistant to moisture absorption by means of a fluorocarbon or silicone-based water repellent treatment, rendering the foam durably hydrophobic. The foam core may be made from melamine or polyimide.

In one embodiment, the textile fabric, also sometime termed a textile fabric membrane, is comprised of a hybrid of fire-resistant combination of rayon, nylon, and para-aramid configured to provide inherent fire resistance without chemical treatment, while the edge binding is an expanded polytetrafluoroethylene (ePTFE membrane), treated to be hydrophobic and oleophobic via a fluorocarbon treatment, with a resistance to water penetration of at least 10,000 mm of H₂O when tested to ISO 811, and air permeable to a level of at least 0.10 ft³/min/ft².

The facing and backing textile fabrics (membranes) may include a fluorocarbon surface treatment configured for providing water repellency and oil resistance.

In one embodiment, the facing and backing textile fabric further includes an electrostatic dissipation carbon matrix layer disposed on an interior surface of at least one of the facing and backing textile fabric that is disposed adjacent to the barrier membrane. The electrostatic dissipation (ESD) carbon matrix layer is configured for providing electrostatic discharge protection to the acoustic and thermal insulation batting. In the preferred embodiment, the electrostatic dissipation (ESD) carbon matrix layer is provided as a printed pattern. The electrostatic dissipation performance provided by the carbon matrix layer is preferably capable of a discharge time of 0.5 seconds or less when charged with 5000 volts.

In the preferred embodiment, the acoustic and thermal insulation batting is configured for being reversibly compressed (meaning that after compression, the batting returns essentially to its original shape and size) to a degree of between 0.5 and 6.0%, and upon recovery from the compression, is able to exert a force (typically a lateral or sideways force) upon the cavity in which it is installed, that is great enough to maintain the original installed position by compression or friction fit.

The invention features, in one preferred embodiment, an acoustic and thermal insulation batting comprising a foam core having a thickness, first and second major planar surfaces, and four edges defined by the foam core thickness and disposed between the first and second major planar surfaces of the foam core. In this embodiment, the foam core is open cell in structure, and preferably treated to be resistant to moisture absorption via a fluorocarbon or silicone-based water repellent treatment, rendering the foam durably hydrophobic.

At least a first barrier membrane is disposed on each of the first and second major planar surfaces of the foam core. The at least a first barrier membrane is preferably an expanded polytetrafluoroethylene (ePTFE) membrane, treated to be hydrophobic and oleophobic via a fluorocarbon treatment, with a resistance to water penetration of at least 10,000 mm of H₂O when tested to ISO 811, and air permeable to a level of at least 0.10 ft³/min/ft².

This embodiment also preferably includes a facing and backing textile fabric, each of which is disposed over the at least a first barrier membrane. An edge binding is also provided and is disposed on the four edges defined by the foam core.

In another preferred embodiment, the acoustic and thermal insulation batting according to the present invention includes a foam core having a thickness, first and second major planar surfaces, and four edges defined by the foam core thickness and disposed between the first and second major planar surfaces of the foam core. The foam core is preferably open cell in structure and treated to be resistant to moisture absorption via a fluorocarbon or silicone-based water repellent treatment, rendering the foam durably hydrophobic.

At least a first barrier membrane is disposed on each of the first and second major planar surfaces of the foam core. The at least a first barrier membrane is an expanded polytetrafluoroethylene (ePTFE) membrane, treated to be hydrophobic and oleophobic via a fluorocarbon treatment, with a resistance to water penetration of at least 10,000 mm of H₂O when tested to ISO 811, and air permeable to a level of at least 0.10 ft³/min/ft². A facing and backing textile fabric membrane are provided which are disposed over the at least a first barrier membrane. The facing and backing textile fabrics may further include an electrostatic dissipation carbon matrix layer, such as a printed pattern, disposed on an interior surface of at least one of the facing and backing textile fabric that is disposed adjacent to the barrier membrane. The electrostatic dissipation carbon matrix layer is configured for providing electrostatic discharge protection to the acoustic and thermal insulation batting. An edge binding is provided and is disposed on the four edges defined by the foam core.

### BRIEF DESCRIPTION OF THE DRAWINGS

These and other features and advantages of the present invention will be better understood by reading the following detailed description, taken together with the drawings wherein:

FIG. 1 is a perspective view of the improved acoustic and thermal insulation batting according to one embodiment of the present invention;

FIG. 2 is a plan view of the improved acoustic and thermal insulation batting according to one feature of the present invention showing the edge protection feature of the invention;

FIG. 3 is an exploded view of the improved acoustic and thermal insulation batting according to the present invention; and

FIG. 4 is an enlarged view of a corner region of the improved acoustic and thermal insulation batting according to the present invention illustrating the edge binding disposed over the edges of the batting.

### DETAILED DESCRIPTION OF THE PREFERRED EMBODIMENTS

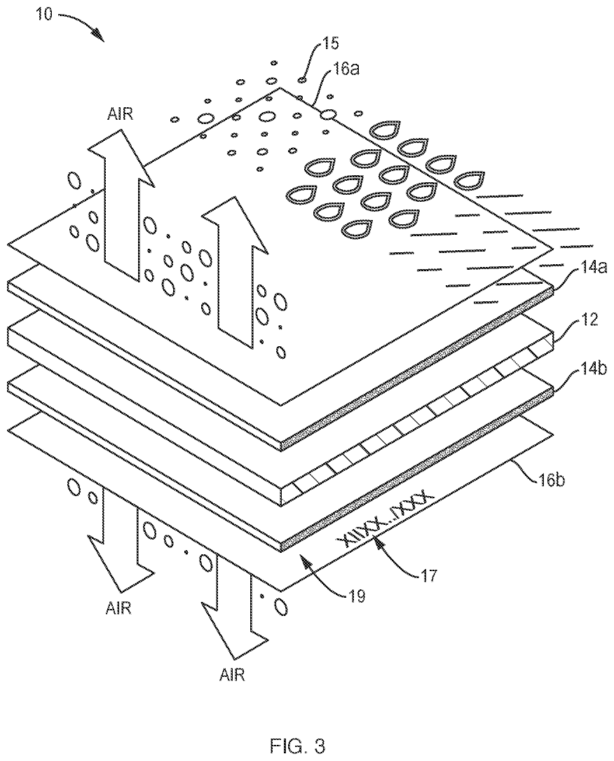

The present invention features, in a first embodiment, an improved acoustic and thermal insulation batting 10, FIGS. 1, 2 and 3, comprising an insulation core 12. In one embodiment, the insulation core 12 is an open cell melamine foam 12 which is treated to be hydrophobic making the core and batting resistant to moisture absorption and moisture retention, thereby ensuring that no moisture is trapped against the airframe when used in an airplane, helicopter or the like. The addition of an air permeable film facing 16a/16b on one or both of the planar faces (and particularly the planar face against the airframe as will be described below) can improve durability of the batting and reduce moisture and/or dust/debris uptake into the core.

The melamine foam 12 typically has a density of between 0.375 to 0.56 lbs/ft³. Other forms are contemplated by the invention including polyimide foam with a density of between 0.34 and 0.44 lbs/ft³. Use of an open cell foam core ensures that the improved acoustic and thermal insulation batting 10 of the present invention is air permeable, while being resistant to compression and sagging caused by vibrations in the aircraft in which it is installed. The length, width and thickness of the foam core 12 forming the batting 10 can vary based on the intended use and placement of the batting and the amount of thermal and acoustic insulation desired.

In one exemplary embodiment, a melamine foam core 12 with a thickness of 2 inches and a density of 0.56 lbs/ft³ provides an insulation R value of 8.3; a thermal conductivity (K) of 0.24 (Btu*in)/(hr*ft²*° F.) and a thermal resistivity (r) of 4.17 (hr*ft²*° F.)/(Btu*in). All these features are provided without providing any increase in weight to the improved acoustic and thermal insulation batting compared with that of the traditional fiberglass insulation batting.

In an alternative embodiment, a polyimide foam core layer 12 is used. For example, such polyimide foams may have a density between approximately 0.34 to 0.44 lbs/ft³. In one embodiment, a polyimide foam with a thickness of 2 inches and a density of 0.44 lbs/ft³ provides an insulation R value of 6.67.

Such foams are stable, lightweight, air permeable and provide high performance in both the thermal and acoustic range. In addition, such core is inherently fire resistant and passes all fire retardant and smoke requirements providing for extremely low flame propagation, smoke generation and toxicity; all very important characteristics for use of a product for insulation in an airplane, helicopter, rail car, buses or even a boat, submarine, ship, or the like. However, these foams, being open cell in nature, are prone to contamination, particularly by particles small enough to enter said open cells, and also prone to tearing or degradation during installation or periodic inspections. As such a means to repel contaminating particles and facilitate installation is needed. The external layers 16 will block some large particles, but the primary means of repelling the fine particles and contaminants will be the barrier membrane layers 14a/14b.

In the preferred embodiment, the improved acoustic and thermal insulation batting 10 includes a barrier membrane 14a/14b, having microscopic pores capable of blocking such small contaminating particles 15. The barrier membranes 14a/14b are disposed against the foam core 12 on the front (outward facing) and back (against the airframe) planar faces of the batting 10. The membrane 14 is a microporous film layer, being substantially waterproof while allowing a certain level of air permeability. In a preferred embodiment, barrier membrane 14 is an ePTFE layer laminated to the foam core 12 and provides a complete barrier to water and oil penetration and filters contaminants to approximately 0.3 μm. The barrier membrane 14 also allows moisture vapor to pass-through directly due to being air permeable, thus ensuring that no condensation or water will build up between the batting 10 and the airframe or other location of installation.

An effective membrane and membrane material 14 shall be air permeable to a level of at least 0.1 CFM when measured per ASTM D737 and have a resistance to water penetration of at least 10,000 mm of H₂O when measured per ISO 811, and provide a filtration efficiency of 99% or greater to 0.5 micron particles, when tested to ASHRAE 52.2.

An additional feature of the present invention includes the provision of a multi-functional, lightweight, and stable facing and backing woven, nonwoven, or knitted textile layer 16a/16b that provides high strength and durability in order to resist tears, provide tensile strength and abrasion resistance so that the batting 10 according to the present invention can survive an aggressive environment. In a preferred embodiment, the facing and backing 16 is a woven textile material weighing less than 5.5 ounces per square yard and comprised of fibers and yarns such that the textile is inherently flame resistant. Such fibers and yarns may be selected from the group of fibers and yarns consisting of meta-aramid, para-aramid, flame resistant rayon, polybenzimidazole, modacrylic, oxidized polyacrylonitrile, polyetherimide, and polyphenylene sulfide. In the preferred embodiment, the facing and backing 16 is a 3.2 ounce per square yard woven FR Rayon, para-aramid, and nylon textile material.

The outer surfaces 18a/18b of the facing and backing layers 16a/16b may receive a fluorocarbon surface treatment for water repellency and oil resistance. Preferably the facing and backing 16 receive a fluorocarbon treatment via a pad bath, dip coating, or vapor deposition process, or the like to treat all surfaces of the facing and backing 16 prior to joining to the membrane 14. The material of the facing and backing 16 provides inherent fire resistance (FR) to the batting 10 without any harmful compounds. In addition, an electrostatic discharge (ESD) carbon matrix layer or pattern may be provided on interior facing planar surfaces of layers 16a/16b that face or confront interior layers 14a/14b.

Preferably, the ESD carbon matrix layer or pattern is achieved using a carbon printing pattern 17 on at least one interior surface 19 of one or more of the facing and/or backing 16 or the barrier membrane 14 as is described, for example, in Patent U.S. Pat. No. 9,204,525 B2 which teachings are incorporated herein by reference. The carbon printing pattern is preferably located on the inner surface 19 of one or both of the facing and backing 16 that comes in contact with the barrier membrane 14 and applied (printed) prior to the facing and backing layers 16a/16b being laminated to membrane 14.

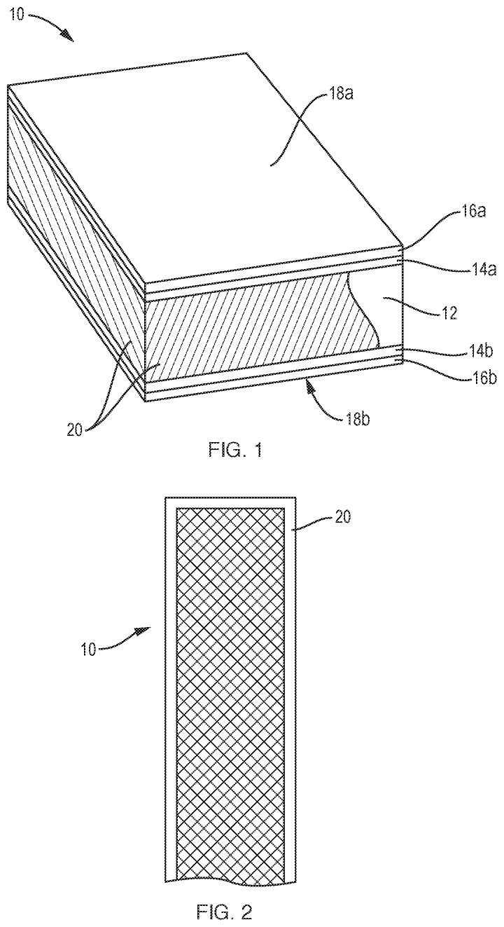

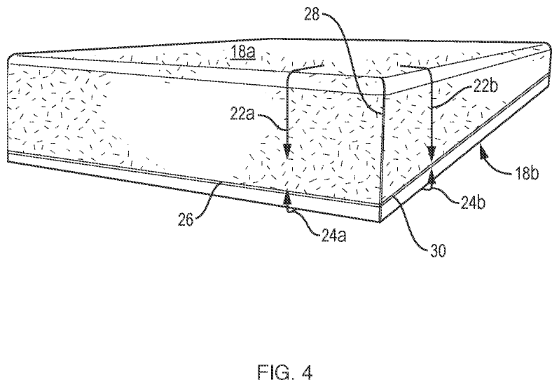

The improved acoustic and thermal insulation batting 10 preferably includes an edge binding 20 which is the same or similar ePTFE membrane to that of the barrier membrane 14a/14b, joined or durably bonded preferably to the same or similar facing and backing 16a/b with an added adhesive layer. The edge binding 20 wraps around the exposed edges of the insulation core 12, sealing off the insulation core 12 from moisture and particulates. The edge binding 20 (See also FIGS. 2 and 4) may be a separate piece added to the insulation batting after the foam core 12, membrane 14, and facing and backing 16 are joined, or it may be an extension of one of the membranes 14 or adjacent facing or backing layers 16, or it may be an extension of both membranes 14a/b and adjacent facing or backing layers 16a/b. In an embodiment where the binding 20 layer is not a separate piece, one of the membrane layers, for example 14a, and adjacent facing layers, for example 16a, can extend beyond the planar surface of the foam core 12, such that the membrane 14a, and facing 16a “wrap around” the thickness of the foam core 12, and extend to the opposite planar surface or extend at least enough to “overlap” one another (one layer overlaps the other) as shown in FIG. 4, where they make contact with and may partially cover or may partially be covered by the opposing membrane 14b and backing 16b in an area around the peripheral edges of the core of the opposing planar surface.

Alternatively, in an embodiment where the binding layer 20 is not a separate piece, at least the facing layers 16a and 16b and also potentially the membrane layers 14a and 14b can all extend beyond the planar surfaces 18a and 18b of the foam core 12 as shown in FIG. 4, such that the membranes 14a and 14b, and facing 16a and 16b “wrap around” the thickness of the foam core 12 as shown by arrows 22a, 22b, 24a and 24b and forming overlapping seams 26, 28 and 30, and cover and fully enclose the foam core 12 thickness to a degree such that the membrane 14a and facing 16a overlap the membrane 14b and backing 14b on the thickness and/or a planar surface of the foam core 12.

Accordingly, the entire improved acoustic and thermal insulation batting 10 is a laminated assembly which is easily field repairable and can also be modified (cut or shaped or the like) to fit a particular geometry or physical location.

An additional feature of the present invention is that the improved acoustic and thermal insulation batting 10 and edge binding 20, when joined together, can be compressed, and recover from such compression without permanent deformation. The acoustic and thermal insulation batting 10 can be sized slightly larger than the cavity it is intended to be installed within. In this way, the batting may be installed with a small amount of compression (i.e. friction fit), in one example between 0.5 and 6.0%, more preferably between 0.5 and 3.0%, and upon recovery from such compression, an outward force continues to be exerted upon the installation cavity such that the improved acoustic and thermal insulation batting maintains its position after installation without the need for additional adhesives, joining mechanisms or other fasteners.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. An acoustic and thermal insulation batting comprising:
a foam core having a thickness, first and second major planar surfaces, and four edges defined by said foam core thickness and disposed between said first and second major planar surfaces of said foam core;
at least a first barrier membrane disposed on each said first and second major planar surfaces of said foam core; and
an edge binding, disposed on said four edges defined by said foam core.

2. The acoustic and thermal insulation batting of claim 1, wherein said at least a first barrier membrane is an expanded polytetrafluoroethylene (ePTFE) membrane, treated to be hydrophobic and oleophobic via a fluorocarbon treatment, with a resistance to water penetration of at least 10,000 mm of H₂₀, and air permeable to a level of at least 0.10 ft³/min/ft².

3. The acoustic and thermal insulation batting of claim 2, further including a facing and backing textile fabric membrane, said facing and backing textile fabric membrane disposed over said at least a first barrier membrane.

4. The acoustic and thermal insulation batting of claim 1, wherein said foam core is open cell in structure, treated to be resistant to moisture absorption by means of a fluorocarbon or silicone-based water repellent treatment, rendering said foam durably hydrophobic.

5. The acoustic and thermal insulation batting of claim 4, wherein said foam core is made from melamine or polyimide.

6. The acoustic and thermal insulation batting of claim 3, wherein said textile fabric is comprised of a hybrid of fire-resistant combination of rayon, nylon, and para-aramid configured to provide inherent fire resistance without chemical treatment.

7. The acoustic and thermal insulation batting of claim 1, wherein said edge binding is an expanded polytetrafluoroethylene (ePTFE membrane), treated to be hydrophobic and oleophobic via a fluorocarbon treatment, with a resistance to water penetration of at least 10,000 mm of H₂O, and air permeable to a level of at least 0.10 ft³/min/ft².

8. The acoustic and thermal insulation batting of claim 3, wherein said facing and backing textile fabric membrane includes a fluorocarbon surface treatment configured for providing water repellency and oil resistance.

9. The acoustic and thermal insulation batting of claim 3, wherein said facing and backing textile fabric membrane further includes an electrostatic dissipation carbon matrix layer, disposed on an interior surface of at least one of said facing and backing textile fabric membrane that is disposed adjacent to said barrier membrane, said electrostatic dissipation carbon matrix layer configured for providing electrostatic discharge protection to said acoustic and thermal insulation batting.

10. The thermal and acoustic insulation batting of claim 9, wherein said acoustic and thermal insulation batting provides electrostatic dissipation performance characteristics capable of a discharge time of 0.5 seconds or less when charged with 5000 volts.

11. The acoustic and thermal insulation batting of claim 1, wherein said acoustic and thermal insulation batting is configured for being reversibly compressed to a degree of between 0.5 and 6.0%, and upon recovery from said compression, is able to exert a force upon a cavity in which it is installed that is great enough to maintain said acoustic and thermal insulation batting in an original installed position.

12. An acoustic and thermal insulation batting comprising:
a foam core having a thickness, first and second major planar surfaces, and four edges defined by said foam core thickness and disposed between said first and second major planar surfaces of said foam core, wherein said foam core is open cell in structure, treated to be resistant to moisture absorption via a fluorocarbon or silicone-based water repellent treatment, rendering said foam durably hydrophobic;
at least a first barrier membrane disposed on each said first and second major planar surfaces of said foam core, wherein said at least a first barrier membrane is an expanded polytetrafluoroethylene (ePTFE) membrane, treated to be hydrophobic and oleophobic via a fluorocarbon treatment, with a resistance to water penetration of at least 10,000 mm of H₂O, and air permeable to a level of at least 0.10 ft³/min/ft²;
a facing and backing textile fabric membrane, said facing and backing textile fabric membrane disposed over said at least a first barrier membrane; and
an edge binding, disposed on said four edges defined by said foam core.

13. An acoustic and thermal insulation batting comprising:
a foam core having a thickness, first and second major planar surfaces, and four edges defined by said foam core thickness and disposed between said first and second major planar surfaces of said foam core, wherein said foam core is open cell in structure, treated to be resistant to moisture absorption via a fluorocarbon or silicone-based water repellent treatment, rendering said foam durably hydrophobic;
at least a first barrier membrane disposed on each said first and second major planar surfaces of said foam core, wherein said at least a first barrier membrane is an expanded polytetrafluoroethylene (ePTFE) membrane, treated to be hydrophobic and oleophobic via a fluorocarbon treatment, with a resistance to water penetration of at least 10,000 mm of H₂O, and air permeable to a level of at least 0.10 ft³/min/ft²;
a facing and backing textile fabric membrane, said facing and backing textile fabric membrane disposed over said at least a first barrier membrane, wherein said facing and backing textile fabric membrane further includes an electrostatic dissipation carbon matrix layer disposed on an interior surface of at least one of said facing and backing textile fabric that is disposed adjacent to said barrier membrane, said electrostatic dissipation carbon matrix layer configured for providing electrostatic discharge protection to said acoustic and thermal insulation batting; and
an edge binding, disposed on said four edges defined by said foam core.
